(19) United States
(12) Patent Application Publication
(10) Pub. No.: US 2014/0173280 A1
(43) Pub. Date: Jun. 19, 2014

(54) DEVICE AUTHENTICATION

(71) Applicant: HEWLETT-PACKARD DEVELOPMENT COMPANY, L.P., Houston, TX (US)

(72) Inventors: Michael S. Bunker, Tomball, TX (US); Michael White, Houston, TX (US); Richard J. Tomaszewski, Houston, TX (US); Jeffrey A. Plank, Cypress, TX (US)

(21) Appl. No.: 14/232,416

(22) PCT Filed: Oct. 25, 2011
(86) PCT No.: PCT/US2011/057607

§ 371 Date: Jan. 13, 2014

(51) Int. Cl. H04L 9/32

(52) U.S. Cl. CPC H04L 9/3271
USPC 713/168

(57) ABSTRACT

An authenticatable device includes a substrate and a computing device with encryption capability affixed to the substrate. The computing device is to receive a challenge value and a first value from a host device, generate a second value based on at least the first value, and generate a response value based on the challenge value and the second value.

### BACKGROUND

A drive carrier is a device designed to accommodate a drive such as a hard disk drive (HDD). A drive carrier typically takes the form of a frame surrounding all or a portion of the drive, and may serve as a protective housing for the drive. For example, the drive carrier may protect the drive from electromagnetic energy interference (EMI) be caused by neighboring drives. Furthermore, the drive carrier may serve to mechanically mate with a drive bay and hold the drive in a particular position within the drive bay.

### BRIEF DESCRIPTION OF THE DRAWINGS

Example embodiments are described in the following detailed description and in reference to the drawings, in which:

FIG. 1 is a block diagram of a system in accordance with embodiments;

FIG. 2 is a graphical representation of a substrate in accordance with embodiments;

FIG. 3 is a graphical representation of how a substrate may be affixed to a drive carrier in accordance with embodiments;

FIG. 4 is a process flow diagram of a portion of the authentication process with respect to a host device;

FIG. 5 is a process flow diagram of a drive carrier authentication process in accordance with embodiments;

FIG. 6 is a block diagram showing non-transitory, computer-readable medium that stores instructions for operating a host device in accordance with embodiments;

FIG. 7 is a block diagram showing non-transitory, computer-readable medium that stores instructions for operating a computing device in accordance with embodiments; and

FIG. 8 is a process flow diagram of a device authentication process in accordance with embodiments.

### DETAILED DESCRIPTION

Disclosed are embodiments for device authentication. In particular, embodiments disclosed therein address the dilemma created by black market or look-alike devices. For example, black market drive carriers are increasingly appearing in the marketplace and cause customer confusion because they purport to be authentic or genuine manufacturer drive carrier. Indeed, some black market drive carriers include all of the manufacturer markings and are virtually indistinguishable to ordinary customers. Customers order such drive carriers believing that they are receiving a genuine manufacturer drive carriers when in fact they are from one of the various black market vendors. This ultimately costs customers unnecessary down time, harms the manufacturer's brand name, and diminishes manufacturer revenue.

In embodiments, an authenticatable drive carrier is provided. The authenticatable drive carrier comprises a substrate and a computing device with encryption capability affixed to the substrate. The computing device resident on the drive carrier is configured to receive a challenge value and a first value from a host device, determine a second value based on at least the first value, and generate a response value based on the challenge value and the second value. This response value may be used by a host device to determine if the drive carrier is authentic, and therefor may help reduce the confusion, down time, brand name harm, and lost revenue created by black market drive carriers.

Additional embodiments provide a method for drive carrier authentication. The method comprises storing a challenge value, a fist value, and a first response value at a host device: transmitting the challenge value and the first value from the host device to a drive carrier via a communication medium; receiving a second response value at the host device from the drive carrier via the communication medium; comparing the first response value and the second response value; and, in response to a determination that the first response value and the second response value are not the same, transmitting from the host device an indication that the drive carrier is not authentic.

Further embodiments are also directed to an authentication method. The method comprises storing, at a computing device, a table comprising a plurality of key values, wherein the plurality of key values are referenced using an index: receiving, at the computing device, a challenge value and a key index value from a host device; selecting, by the computing device, one of the plurality of key values based on the received key index value; and generating, by the computing device, a response value based on the challenge value and the selected key value. This response value may be provided to a host device to assist with an authentication determination, and therefore may facilitate black market device reduction.

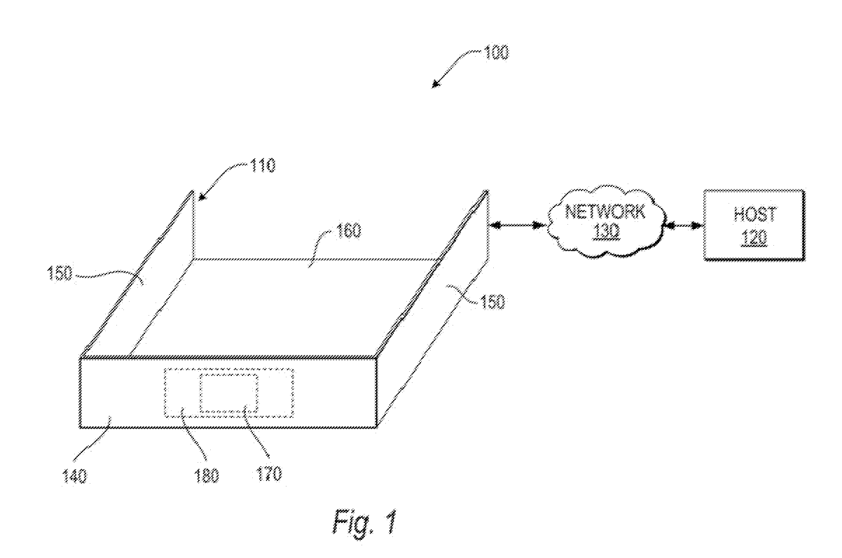

FIG. 1 is a block diagram of a system 100 in accordance with some embodiments. The system 100 may comprise a drive carrier 110 communicating with a host drive 120 via network 130. While only one drive carrier 110, host device 120, and network 130 is shown, it should be understood that the system 100 may include a plurality of drive carriers, host devices, and/or networks collaborating and communicating with one another in accordance with embodiments.

The drive carrier 110 may be constructed of plastic, metal, and/or other materials. It may include a front plate or bezel 140, opposing sidewalls 150, and a floor 160. A drive (not shown), such as a hard disk drive (HDD), solid state drive (SSD), or hybrid drive, may be placed within and/or attached to the area formed by the opposing sidewalls 150, floor 160, and front plate 140. The HDD may use spinning disks and movable read/write heads. The SSD may use solid state memory to store persistent data, and use microchips to retain data in non-volatile memory chips. The hybrid drive may combine features of the HDD and SSD into one unit containing a large HDD with a smaller SSD cache to improve performance of frequently accessed files. Other types of drives such as flash-based SSDs, enterprise flash drives (EFDs), etc. may also be used with the drive carrier 110.

The drive carrier 110 may further comprise a computing drive 170 affixed to a substrate 180. The substrate 180 may be, for example, a rigid or flexible printed circuit board (PBC). The computing device 170 may be, for example, a microcontroller, microprocessor, processor, expander, driver, and/or computer-programmable logic device (CPLD). In embodiments, the computing device 170 may have encryption capability. The encryption capability may be realized via firmware, software, and/or other computer-executable instructions on the computing device 170 which cause the computing device 170 may conduct operations consistent with the advanced encryption standard (e.g., AES-128, AES-192, AES-256, etc.), the data encryption standard (DES), the triple data encryption algorithm (TDEA or Triple DEA), Blowfish, Serpent, Twofish, Camellia, CAST-128, CAST5, the international data encryption algorithm (IDEA), RC2, RC5, SEED, Skipjack, the tiny encryption algorithm (TEA), the extended TEA (XTEA), 3-Way, ABC, Akelarre, Anubis, ARIA, BaseKing, BassOmatic, BATON, BEAR and LION, CAST-256, CIKS-1, CIPHERUNICORN-A, CIPHERUNICORN-E, CLEFIA, the cellular message encryption algorithm (CMEA), Cobra, COCONUT98, Crab, Cryptomeria/C2, CRYPTON, CS-Cipher, the data encryption algorithm with larger blocks (DEAL), DES-X, decorrelated fast cipher (DFC), E2, the fast data encipherment algorithm (FEAL), fast encryption algorithm for multimedia (FEA-M), FROG, the generalized DEC scheme (G-DES), GOST, Grand Cru, Hasty Pudding, Hierocrypt, ICE, IDEA NXT, Intel Cascade Cipher, Iraqi, KASUMI, KeeLoq, KHAZAD, Khufu and Khafre, KN-Cipher, Ladder-DES, Libelle, LOKI97, LOKI89/91, Lucifier, M6, M8, MacGuffin, Madryga, MAGENTA, MARS, Mercy, MESH, MISTY1, MMB, MULTI2, MultiSwap, New Data Seal, NewDES, Nimbus, NOEKEON, NUSH, Q, RC6, REDOC, Red Pike, S-1, SAFER, SAVILLE, SC2000, SHACAL, SHARK, SMS4, Spectr-H64, Square, SXAL/MBAL, Threefish, Treyfer, UES, Xeron, xmx, XXTEA, Zodiac, or other ciphers.

The host device 120 may be, for example, a disk array controller, RAID controller, disk controller, a host bus adapter, an expander, and/or a server. The host device may comprise a processor (not shown) which executes instructions stored on an associated computer-readable medium such as a memory (not shown) to effectuate the host device functionality described herein. The host device 120 may further comprise a communication interface (not shown) for communicating with, e.g., the computing device 170 on the drive carrier 110 or other devices via the network 130.

Network 130 may interconnect the host device 120 and the computing device 170. Network 130 may comprise a serial communication bus, a parallel communication bus, an Inter-Integrated Circuit (I²C) bus, a wired link, a wireless link, a local area network (LANs), a wide area network (WAN), a telecommunication network, the Internet, a computer network, a Bluetooth network, an Ethernet LAN, an token ring LAN, a serial advanced technology attachment (SATA), and/or a serial attached SCSI (SAS).

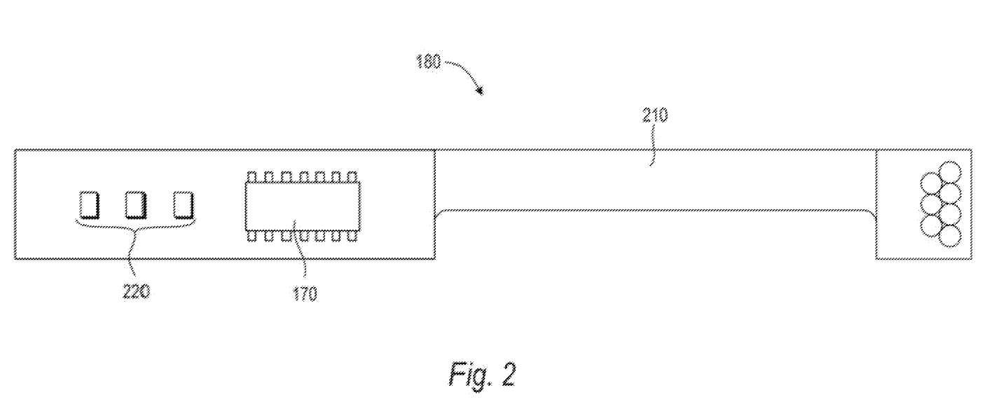

FIG. 2 is a graphical representation of substrate 180 in accordance with embodiments. In particular, FIG. 2 depicts a flexible printed circuit board 210 with a computing device 170 and multiple light sources 220 affixed thereon. In addition to providing authentication operations, the computing devices 170 may be configured to control the light sources 220 to provide, e.g., a drive locate indication, a do not remove indication, and/or a self-describing animated activity indication.

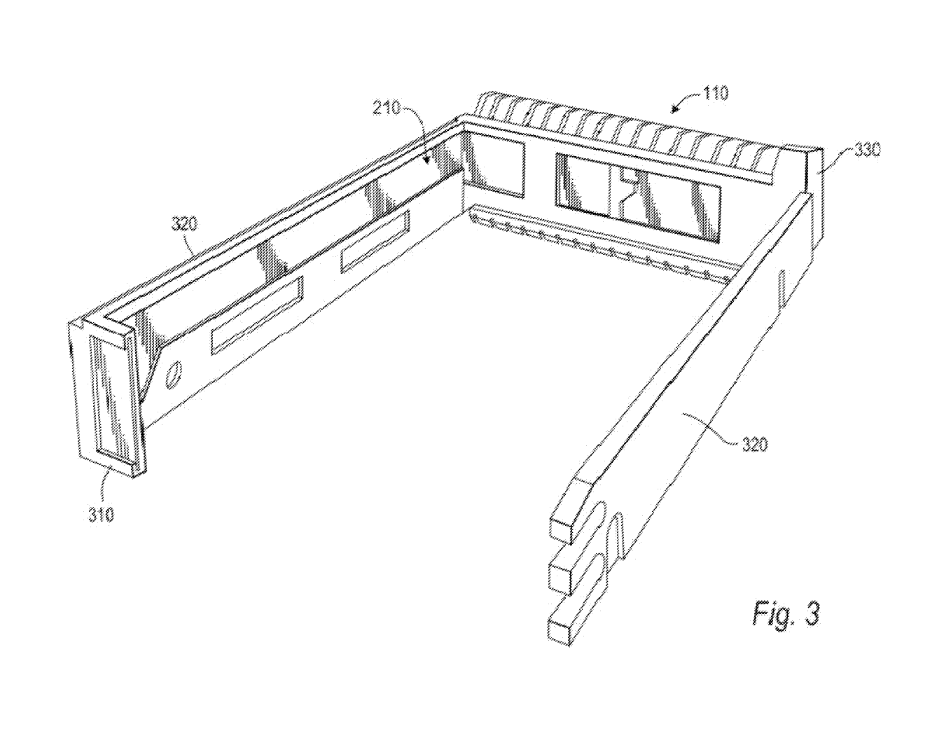

FIG. 3 is a graphical representation of how the flexible printed circuit board 210 of FIG. 2 may be affixed to the drive carrier 110 in accordance with embodiments. As shown, the flexible printed circuit board 210 may coupled to the rear of the drive carrier 310, one of the opposing sidewalls 320, and the front of the drive carrier 330. Of course, alternate configurations may also be used in accordance with embodiments. For example, in embodiments, a rigid printed circuit board may be affixed to the rear of the drive carrier 310, one of the opposing sides 320, and/or the front of the drive carrier 330.

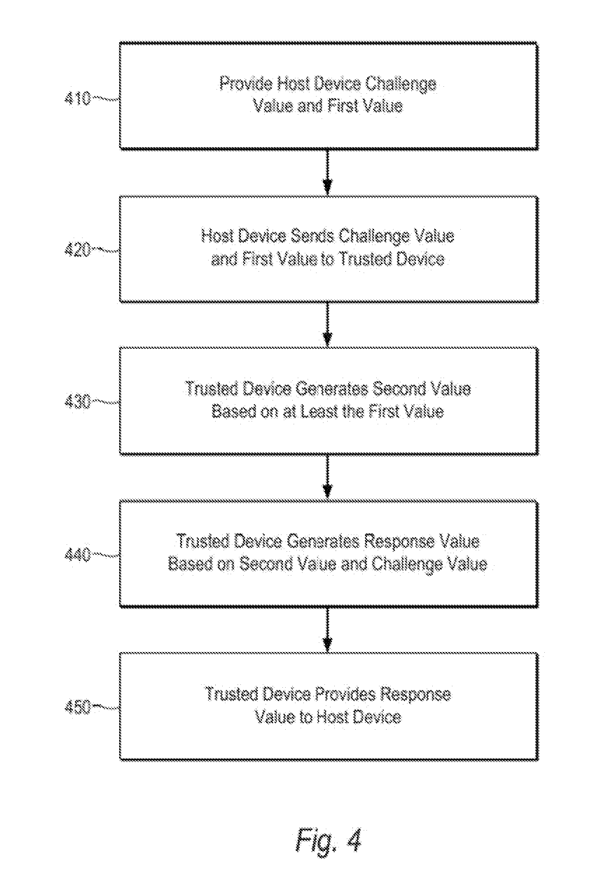

FIG. 4 is a process flow diagram of a portion of the authentication process with respect to the host device 120 in accordance with embodiments. More precisely, FIG. 4 describes the authentication processes to initialize of program the host device 120 in accordance with embodiments. This process may begin at block 410 and may occur at the host device factory, manufacturing facility, or the like. The host device 120 may be a new host device, a refurbished host device, or another type of host device that will be entering or re-entering the marketplace. At block 410, the host device 120 (e.g., an array controller) may receive a challenge value and a first value from a functional board test (FBT) application running on a server device. The challenge value and first value may be stored in, e.g., a non-volatile storage medium at the host device 120. In embodiments, the challenge value and first value may be pseudo-random numbers generated by the FBT application or another server application. Furthermore, in embodiments, the challenge value may be a 16-byte number and the first value may be a 1-byte number. While other size values may also be used in accordance with embodiments (e.g., 32-byte, 64 bytes, etc. ), 16-byte and 1-byte for the challenge value and first value, respectively, will be used for the remainder of this example.

At block 420, the host device 120 sends the stored challenge value and first value to a trusted device such as a trusted drive carrier. At block 430, the trusted device generates a second value based on at least the first value. In embodiments, the computing device may generate the second value by inputting the first value into a function. In further embodiments, the first value may be a key index value and the second value my be one of a plurality of key values stored in a table. The plurality of key values may be referenced using an index, and therefore the computing device may determine the second value by identifying one of the plurality of key values stored in the table based on the key index value. For example, the key index value (i.e., first value) may be a 1-byte random number (i.e., 256 random combinations) and the table may store 256 key values. Based on the received 1-byte random number, the computing device may identify one of the 256 values from the table (i.e., the second value).

At block 440, the trusted device generates a response value (e.g., a 16-byte response value) by encrypting the challenge value with the second value. That is, the trusted device inputs the challenge value and the second value into an encryption algorithm to arrive at a response value. The encryption algorithm may be one of the previously mentioned encryption algorithms. For example, in embodiments the trusted device may input a 16-byte second value and a 16-byte challenge value into the AES-128 encryption algorithm to arrive at a 16-byte response.

At block 450, the trusted device provides the response value to the host device 120. The host device 120 may then store this response value in a non-volatile storage medium along with the challenge value and first value. In embodiments, the host device 120 may conduct the above-mentioned process multiple times to confirm that the response value is the same for each iteration.

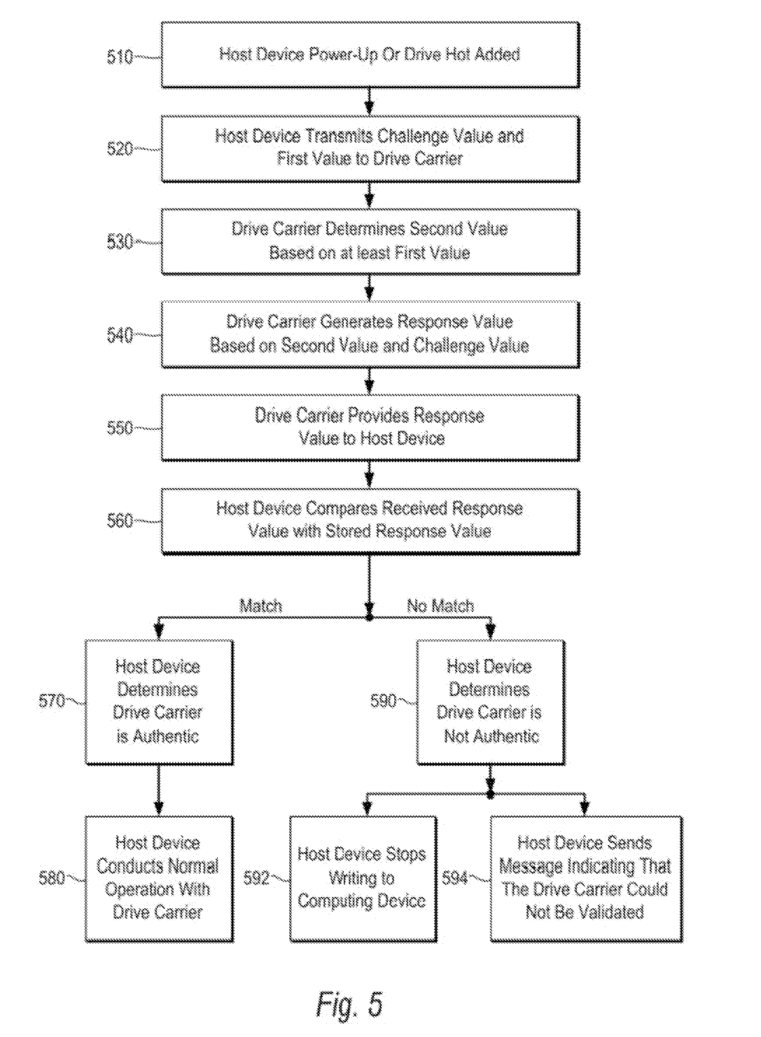

Following the above mentioned processes, the host device 120 may have stored thereon a challenge value, a first value, and a response value. As discussed in detail below with respect to FIG. 5, the host device 120 may then use these values to authenticate drive carriers in the marketplace. In particular, the host device 120 may conduct a challenge-response authentication process with various drive carriers to confirm that they are authentic and not black market or counterfeit drive carriers.

FIG. 5 is a process flow diagram of the drive carrier authentication process in accordance with embodiments. The process may involve the drive carrier 110 and host device 120 as reference in FIG. 1. The process may begin at block 510, when the host device powers-up or a drive is hot-added into a hot-plug drive bay.

At block 520, in response to the host device powering-up or a drive being hot-added, the host device 120 transmits a challenge value (e.g., 16-byte challenge value) and a first value (e.g., a 1-byte value) to a computing device 170 on the drive carrier 110. In embodiments, this challenge value and first value may be sent to a plurality of drive carriers in parallel for parallel authentication.

At block 530, the computing device 170 generates a second value based at least on the first value. As discussed above, this may accomplished via a function and/or via a table with plurality of keys referenced with an index.

At block 540, the computing device 170 generates a response value (e.g., a 16-byte response value) by encrypting the challenge value with the second value. That is, the computing device 170 inputs the challenge value and the second value into an encryption algorithm to arrive at a response value. The encryption algorithm may be one of the previously mentioned encryption algorithms. For example, in embodiments the computing device 170 may input a 16-byte second value and a 16-byte challenge value into the AES-128 encryption algorithm to arrive at a 16-byte response.

At block 550, the computing device 170 provides the response value to the host device 120. At block 550, the host device 120 compares the received response value with the response value stored therein and as mentioned above. If the two response values match, the host device 120, at block 570, determines that the drive carrier is authentic. The host device 120 then continues normal operation/communication with the drive carrier 110 at block 580. On the other hand, if the host device 120 determines that the two response value do not match, at block 590, the host device 120 determines that the drive carrier is not authentic. In response to this determination, the host device 120 may stop writing to the computing device 170 at block 592. Alternatively or in addition, the host device 120 may send a message indicating that the drive carrier could not be validated as genuine at block 594.

The message may be a message to the system event log on a server. For example, the host device 120 may send a message indicating that the hard drive carrier located at, e.g., PCI Slot=W, Port=XX, Box=Y, and Bay=Z, could not be authenticated as a genuine manufacturer hard drive. The host device 120 may further indicate that it will not control the computing device 170 or not control the light sources(s) 220 associated therewith.

Alternatively or in addition, the message may be a message to OS Storage Agents (e.g., simple network message protocol (SNMP), Windows Management Instrumentation (WMI), etc) or agent that polls the host device 120. The message may similarly indicate that the hard drive carrier located at, e.g., PCI Slot=W, Port=XX, Box=Y, and Bay=Z, could not be authenticated as a genuine manufacturer hard drive. Or, that the host device 120 will not control the computing device 170 or not control the light sources(s) 220 associated therewith.

Alternatively or in addition, the message may be a message to an array configuration utility (ACU). This message may be a failed authentication ACU message from controller status message or a failed authentication ACU message from hard drive more information message indicating, e.g., that the hard drive carrier located at PCI Slot=W, Port=XX, Box=Y, and Bay=Z, could not be authenticated as a genuine manufacturer hard drive. Or, that the host device 120 will not control the computing device 170 or not control the light sources 220 associated therewith. Alternatively or in addition, such messages may be sent to an array diagnostic utility (ADU).

Furthermore, the message may be a power-on self test (POST) message. If sent from a smart array controller or array controller type host device 120, such a message may indicate that one or more attached hard drive carriers could not be authenticated as genuine manufacturer drives carriers and/or that the smart array controller or array controller will not control the light source(s) associated with these drive carriers. Moreover, the smart array controller or array controller may request that a ACU or ADU be run to learn which drives could not be validated as genuine. If sent from a HBA-type host devices, such a message may indicate that one or more attached hard drive carriers could not be authenticated as genuine manufacturer drives carriers and/or that the HBA will not control the light sources associated with these drive carriers. Furthermore, the HBA may request that the System Event Log be viewed to learn which drive could not be validated as genuine.

In some embodiments, a determination by the host device 120 that a drive carrier 110 is not authentic will not result in preventing input/output traffic from the physical drive. That is, even if a drive carrier is determined to be non-authentic, the drive associated therewith may nonetheless continue input/output operations via, e.g., a SAS fabric. However, light sources associated with the drive may be barred from illuminating.

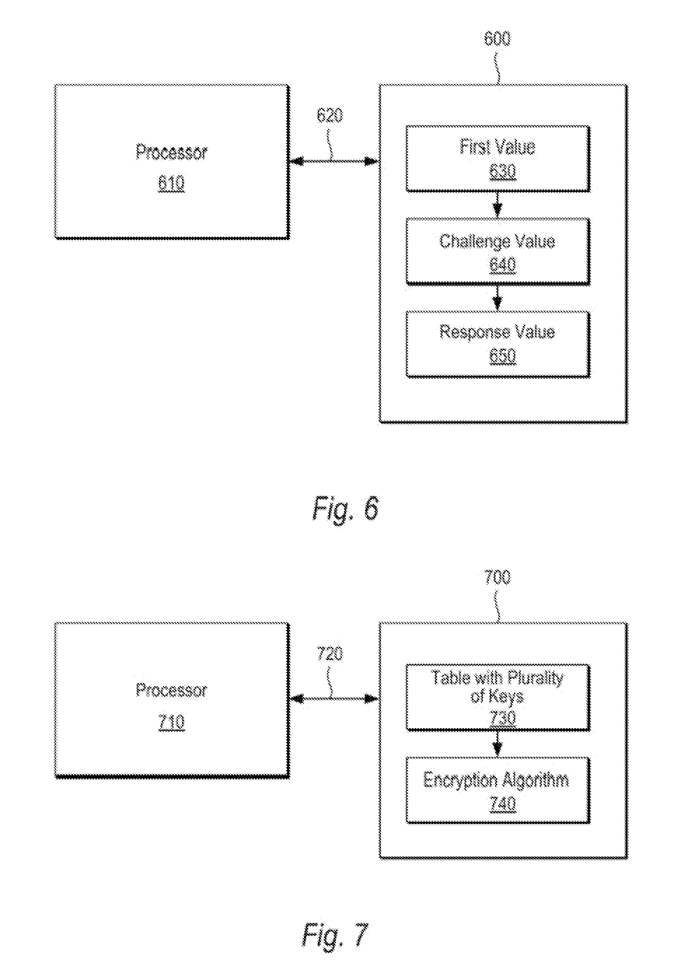

FIG. 6 is a block diagram showing a non-transitory, computer-readable medium that stores code for operating a host device 120 in accordance with embodiments. The non-transitory, computer-readable medium is generally referred to by reference number 600 and may be included in the host device 120. The non-transitory, computer-readable medium 600 may correspond to any typical storage device that stores computer-implemented instructions, such as programming code or the like. For example, the non-transitory, computer-readable medium 600 may include one or more of a non-volatile memory, a volatile memory, and/or one or more storage devices. Examples of non-volatile memory include, but are not limited to, electronically erasable programmable read only memory (EEPROM), flash memory, and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical drive, and flash memory devices.

A processor 610 generally retrieves and executes the instructions stored in the non-transitory, computer-readable medium 600 to operate the host device 120 in accordance with embodiments. In an embodiment, the non-transitory computer-readable medium 600 can be accessed over a communication bus 620. Furthermore, in embodiments, the non-transitory computer-readable medium 600 may be configured to store a first value 630, a challenge value 640, and a response value 650, as described above with respect to FIGS. 4 and 5. Specifically, the host device 120 may store these values to use as part of the above-mentioned drive carrier 110 authentication process.

FIG. 7 is a block diagram showing a non-transitory, computer-readable medium that stores code for operating a computing device 170 in accordance with embodiments. The non-transitory, computer-readable medium is generally referred to by reference number 700 and may be included or otherwise associated with the computing device 170. The non-transitory, computer-readable medium 700 may correspond to any typical storage device that stores computer-implemented instructions, such as programming code or the like. For example, the non-volatile computer-readable medium 700 may include one or more of a non-volatile memory, a volatile memory, and/or one or more storage devices. Examples of non-volatile memory include, but are not limited to, electronically erasable programmable read only memory (EEPROM), flash memory, and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical drive, and flash memory devices.

A processor 710 generally retrieves and executes the instructions stored in the non-transitory, computer-readable medium 700 to operate the computing device 170 in accordance with embodiments. In an embodiment, the non-transitory computer-readable medium 700 can be accessed over a communication bus 720. Furthermore, in embodiments, the non-transitory computer-readable medium 700 may be configured to store a table with a plurality of keys referenced via an index 730 and an encryption algorithm 470. As described above with respect to FIGS. 4 and 5, the computing device 170 may determine a second value from the table based on the first value 630 received from the host device 120. The computing device 170 may then generate a response value based on the second value and challenge value 640 received from the host device 120. More precisely, the computing device 170 may generate the response value by inputting the second value and challenge value 640 into an encryption algorithm (e.g., the AES-128 encryption algorithm). The host device 120 may compare this response value with the response value 650 stored therein to determine if the drive carrier 110 is authentic.

In embodiments, the authentication process may be the first process upon boot up or hot adding a drive and may be performed prior to any writes to update the Smart Carrier LEDs. The computing device 170 may input two values (the challenge value & the second value) to an AES-128 algorithm and receive one output (the response value). The host devices 120 may compare this response value with a response value stored therein via factory programming to determine if the drive carrier 110 is authentic.

With particular respect to host device 120 factory programming, FBT software may select a unique challenge value (e.g., a 16-byte random or pseudo-random number and a unique first value (e.g., a 1-byte random or pseudo-random number. The FBT software may then issue a special factory command to the host device 120 that provides the first value and challenge value. The host device 120 may then challenge a trusted drive carrier and learn the response value (e.g., a 16-byte response). In embodiments, the host device 120 may conduct this process twice to determine the response value twice. If both response values match, host device 120 may then program the first value, the challenge value, and the response value into its on-board memory with proper checksum. In embodiments, if the host device 120 is a controller of HBA, it may send the challenge value and first value to any expanders attached to allow the expander to also generate a response value and program its own on-board memory. Accordingly, each host device 120 (e.g., controller, HBA, expander, and/or server) stores therein a challenge value, a response value, and a first value that is to be used by the host device 120 to authenticate one or more drive carriers.

Specifically, the drive carrier authentication process may comprise the host device 120 transferring the the above-described challenge value and first value from an on-board memory to the drive carrier 110. This may occur during the host device 120 power-up and/or after a drive carrier is hot-added into a hot-plug drive bay. Upon reception of the challenge value and the first value from the host device 120, the drive carrier 110 may determine a second value (e.g., via a function or key look-up table). The computing device may then create a response value using an encryption algorithm (e.g., the AES-128 encryption algorithm) to encrypt the challenge value and the second value. The host device 120 may then read the response value from the drive carrier 110 or otherwise receive the response value and compare it with the expected response value stored therein. If the two responses match, the drive carrier 110 is determined to be authentic. If the two response values do not match, the drive carrier 110 is determined to be non-authentic. In embodiments, the host device 110 may repeat the challenge-response value multiple times before concluding that the drive carrier 110 is not authentic. Furthermore, in embodiments, if the host device 120 determines that the drive carrier 110 is not authentic, the host device 110 may stop performing all writes to the computing device 170 on the drive carrier 110. However, in embodiments, hard drive input/output traffic may still be allowed. Further, host device 110 may transmit one or more messages to inform a user and/or administrator that a drive carrier could not be validated as genuine. The one ore more messages may further inform the user and/or administrator that the host device is no longer controlling drive carrier light sources 220. Hence, embodiments described herein enable customers to determine whether or not drive carriers are authentic, and may therefore curtail the proliferation of non-authentic drive carriers in the marketplace.

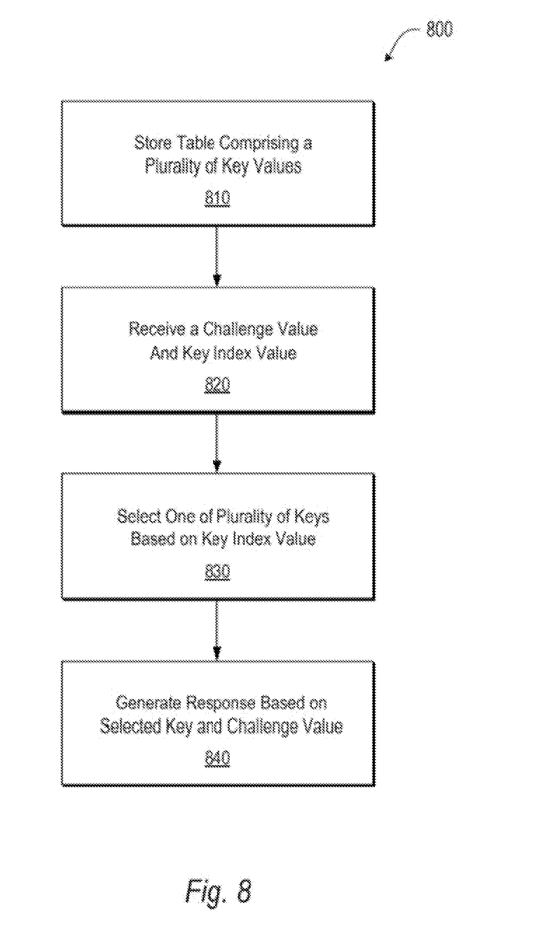

In some embodiments, the authentication process may be used to authenticate devices other than drive carriers. For example, the host device may authenticate pluggable devices, memory devices, host bus adapter, power supplies, input/output modules, fans, network interface controllers, gigabit interface converters, peripherals (mouse, keyboard, scanners, speakers, webcams, etc.), transceivers, and/or mezzanine cards. Such devices may include a computing device which communicates with the host device to provide a response value based on a received challenge value and a first value, as described above. FIG. 8 is a process flow diagram of such a device authentication process in accordance with embodiments. The process may involve a device and a host device 110. The process may begin at block 810, when a computing device of the device stores a table comprising a plurality of key values, wherein the plurality of key values are referenced using an index. At block 820, the computing device may receive a challenge value and a key index value from the host device. At block 830, the computing device may select one of the plurality of key values in the table based on the received key index value. At block 840, the computing device may generate a response value based on the challenge value and the selected key value (e.g., by inputting the challenge value and the selected key value into an encryption algorithm). The computing device may then provide the response value to the host device in order for the host device to determine whether or not the device is authentic.

1. An authenticatable drive carrier, comprising:
a substrate; and
a computing device with encryption capability affixed to the substrate, wherein the computing devices is to
receive a challenge value and a first value from a host device;
determine a second value based on at least the first value; and
generate a response value based on the challenge value and the second value.

2. The authenticatable drive carrier of claim 1, wherein the first value is a key index value and the second value is one a plurality of key values stored in a table, wherein the plurality of key values are referenced using an index.

3. The authenticatable drive carrier of claim 1, wherein the computing device is to determine the second value by inputting at least the first value into a function.

4. The authenticatable drive carrier of claim 1, wherein the computing device is to generate the response value by inputting the challenge value and the second value into an encryption algorithm.

5. The authenticatable device carrier of claim 4, wherein the encryption algorithm is to operate in accordance with the advanced encryption standard.

6. The authenticatable drive carrier of claim 1, wherein the challenge value is a pseudo-randomly generated number and the first value is a pseudo-randomly generated number.

7. The authenticatable drive carrier of claim 1, wherein the host device is an array controller, a host bus adapter, an expander, or a server.

8. the authenticatable drive carrier of claim 1, wherein the response value is used by the host device to determine if the drive carrier is authentic.

9. An authentication method, comprising:
storing, at a computing device, a table comprising a plurality of key values, wherein the plurality of key values are referenced using an index;
receiving, at the computing device, a challenge value and a key index value from a host device;
selecting, by the computing device, one of the plurality of key values based on the received key index value; and
generating, by the computing device, a response value based on the challenge value and the selected key value.

10. The method of claim 9, wherein generating the response value based at on the challenge value and the selected key value comprises inputting the challenge value and the selected key value into an encryption algorithm.

11. The method of claim 9, wherein the computing device is located on a drive carrier.

12. The method of claim 9, wherein the plurality of key values are stored in a secure portion of the computing device.

13. A method for drive carrier authentication, comprising:
storing a challenge value, a first value, and a first response value at a host device;
transmitting the challenge value and the first value from the host device to a drive carrier via a communication medium;
receiving a second response value at the host device from the drive carrier via the communication medium;
comparing the first response value and the second response value; and
in response to a determination that the first response value and the second response value are not the same, transmitting from the host device an indication that the drive carrier is not authentic.

14. The method of claim 13, further comprising discontinuing write operations to a computing device on the drive carrier in response to the determination that the first response value and the second response value are not the same.

15. The method of claim 13, wherein the host device is an array controller, a host bus adapter, an expander, or a server.
